(19) United States
(12) Patent Application Publication
(10) Pub. No.: US 2012/0293730 A1
(43) Pub. Date: Nov. 22, 2012

(54) BACKLIGHT DEVICE, LIQUID CRYSTAL DISPLAY DEVICE, AND TELEVISION RECEIVER

(75) Inventor: Munetoshi Ueyama, Osaka (JP)

(73) Assignee: SHARP KABUSHIKI KAISHA, Osaka (JP)

(21) Appl. No.: 13/576,357

(22) PCT Filed: Jan. 18, 2011
(86) PCT No.: PCT/JP2011/050697

§ 371 Date: Jul. 31, 2012

(30) Foreign Application Priority Data
Feb. 12, 2010 (JP) 2010-028350

(51) Int. Cl. F21V 8/00; H04N 3/14

(52) U.S. Cl. 348/790; 362/613; 348/E03.016

(57) ABSTRACT

Disclosed are a side light-type backlight device with high brightness and excellent light use efficiency, a liquid crystal display device and a television receiver. The backlight device according to the present invention is provided with a light guide plate, a prescribed side surface of which is a light incident surface, and a light source that is disposed so as to face the light incident surface of the light guide plate. The light source includes a plurality of side-emitting LEDs mounted on a substrate, and the plurality of LEDs are arranged on two levels in the vertical direction along the light incident surface.

### TECHNICAL FIELD

The present invention relates to a side-lighting type backlight device that is equipped with an LED light source and a light guide plate, a liquid crystal display device, and a television receiver.

### BACKGROUND ART

Conventional backlight devices that are used for liquid crystal display devices include a side-lighting type backlight device in which a light source is disposed near a side surface of a light guide plate, a direct-lighting type backlight device in which a light source is disposed directly below a liquid crystal panel, and the like. The side-lighting type backlight device is used for small and medium-sized liquid crystal display devices and liquid crystal display devices that require thin-profile, in particular. The direct-lighting type backlight device is used for large liquid crystal televisions and the like. Conventionally, the light source of these backlight devices was mainly made of cold-cathode fluorescent lamps (CCFLs), but recently, with an increasing awareness of environmental issues, the CCFLs have been replaced by LEDs that consume less power and contain no mercury.

Patent Document 1 discloses a side-lighting type backlight device that uses LEDs, for example. As shown in FIG. 5, Patent Document 1 includes a flat plate-shaped light conductor 130 that has a light-emitting surface on a front surface thereof and that guides light, a flat plate-shaped reflector 140 that is disposed on a rear side of this light conductor 130, and light sources that are disposed on the opposite ends of the light conductor 130 and that are made of a plurality of lamp units L aligned and connected to each other. The lamp unit L includes two LEDs 120 and 121 that are connected in series. Light from the lamp units L is diffused and reflected by the light conductor 130 and the reflector 140, and is emitted to the outside through the light-emitting surface of the light conductor 130, thereby achieving a uniformly bright light-emitting surface, stable light supply, prevention of characteristics degradation, thinner-profile, modularization, and the like.

### RELATED ART DOCUMENT

### Patent Document

Patent Document 1: Japanese Patent Application Laid-Open Publication No. H7-64078

### Problems to be Solved by the Invention

However, in the backlight device of Patent Document 1, a light source is made of a group of six lamp units L, each of which has two LEDs, and the light sources are disposed on the opposite ends of the light conductor 130 and the reflector 140 by using lamp holders 150 and 151. This makes the structure of the backlight device complex, and increases the number of components, causing a problem of increasing the price of the backlight device. With the increase of the number of components, the number of connecting points of the respective components is increased, and therefore, a bad connection between the LED and the lamp unit or between the lamp unit and a driver board, for example, becomes more likely to occur, resulting in a problem of lowering the reliability of the backlight device. Also, a recent liquid crystal display device has a smaller frame area, and when arrangement space of the light source can only be provided on one side of the light conductor, for example, because the lamp unit takes up a lot of space, the number of LEDs that can be installed as a light source is reduced, causing a problem of lowering the brightness of the backlight device.

The present invention was made in view of the above-mentioned problems, and is aiming at reducing the number of components, improving the reliability, and enhancing the brightness of a backlight device and a liquid crystal display device.

### SUMMARY OF THE INVENTION

### Means for Solving the Problems

A backlight device and a liquid crystal display device according to the present invention include a light guide plate having a light incident surface on a prescribed side surface and a light source that is disposed so as to face the light incident surface of the light guide plate, wherein the light source is made of a plurality of LEDs that are mounted on a substrate, and the plurality of LEDs are arranged in two levels in a vertical direction along the light incident surface.

### Effects of the Invention

According to the present invention, by arranging a plurality of LEDs compactly as a light source, it becomes possible to reduce the number of components, to improve reliability, and to enhance the brightness of the backlight device.

### BRIEF DESCRIPTION OF THE DRAWINGS

FIG. 1 is a perspective view for illustrating a backlight device and a liquid crystal display device of Embodiment 1.

FIG. 2a is a front view (a) of a light source in the backlight device of Embodiment 1.

FIG. 2b is a front view (b) of the light source in the backlight device of Embodiment 1.

FIG. 3a is a front view (a) of a light source in a backlight device of Embodiment 2.

FIG. 3b is a front view (b) of the light source in the backlight device of Embodiment 2.

FIG. 3c is a front view (c) of the light source in the backlight device of Embodiment 2.

FIG. 3d is a front view (d) of the light source in the backlight device of Embodiment 2.

FIG. 4a is a plan view and a front view (a) of a light source in a backlight device of Embodiment 3.

FIG. 4b is a plan view and a front view (b) of the light source in the backlight device of Embodiment 3.

FIG. 5 is a cross-sectional view of a conventional backlight device.

### DETAILED DESCRIPTION OF EMBODIMENTS

Below, preferred embodiments of a backlight device and a liquid crystal display device of the present invention will be explained with reference to figures. In the descriptions below, an example in which the present invention is applied to a transmissive liquid crystal display device will be explained.

### Embodiment 1

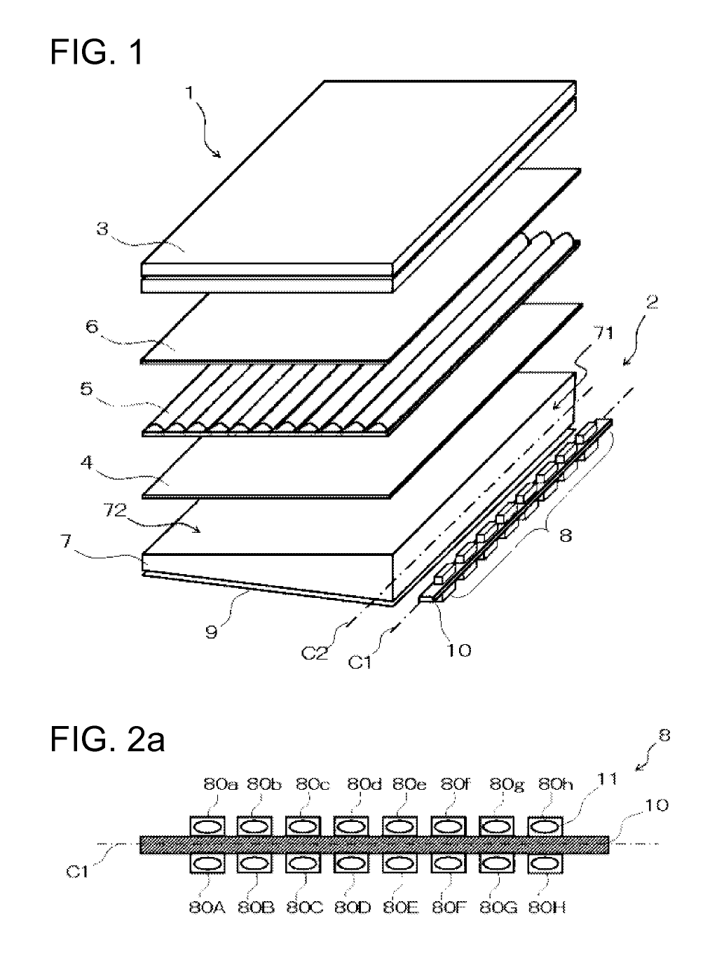

FIG. 1 is a perspective view for illustrating a backlight device and a liquid crystal display device according to Embodiment 1 of the present invention. As shown in FIG. 1, in a liquid crystal display device 1, a backlight device 2 and a liquid crystal panel 3 that receives light from the backlight device 2 are held as a single unit.

The liquid crystal display device 1 also includes a diffusion sheet 4, a prism sheet 5, and a polarizing sheet 6 disposed between the backlight device 2 and the liquid crystal panel 3, for example, and with these optical sheets, the brightness of the light emitted from the backlight device 2 is made uniform, which improves the display performance of the liquid crystal panel 3.

The backlight device 2 has a side-lighting type structure in which a light source 8 is provided near a prescribed side surface of a light guide plate 7. The light guide plate 7 is made of a synthetic resin such as a transparent acrylic resin, and is formed substantially in a wedge shape, for example. A side surface of the light guide plate 7 on the thicker side is a light incident surface 71, and a top surface of the light guide plate 7 is a light emerging surface 72. The light source 8 is disposed so as to face the light incident surface 71. Below the light guide plate 7, a reflective sheet 9 is disposed so as to efficiently reflect light from the light source 8 toward the liquid crystal panel 3 above.

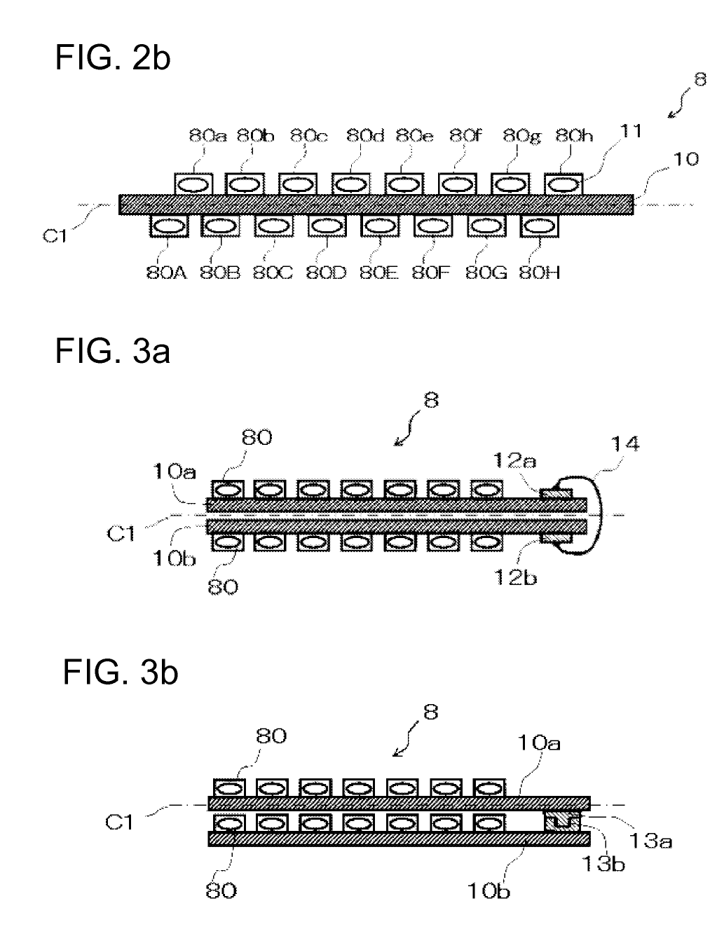

FIG. 2 shows front views of the light source 8 when viewed from the light incident surface 71. As shown in FIGS. 2(a) and 2(b), the light source 8 is made of a plurality of side-emitting LEDs 80 that are mounted on a substrate 10. The plurality of LEDs 80 are disposed on the substrate such that respective light-emitting surfaces 11 thereof face the same direction. LEDs 80a to 80h of an upper level are mounted on the top surface of the substrate 10, and LEDs 80A to 80H of a lower level are mounted on the bottom surface of the substrate 10. By mounting the LEDs 80 on the opposite surfaces of the substrate 10 in this way, the difference in the linear expansion coefficient and the elastic modulus between the LEDs 80 and the substrate 10 are cancelled and balanced out between the two surfaces of the substrate 10, and therefore, deformation of the substrate 10 due to warping can be prevented. The upper level LEDs 80 and the lower level LEDs 80 are connected to each other in series, for example, via through holes formed in the substrate 10. As shown in FIG. 1, the plurality of LEDs 80 mounted on the substrate 10 are disposed on the side surface of the light guide plate 7 such that the light-emitting surfaces 11 face the light incident surface 71.

According to the present invention, as described above, the plurality of side-emitting LEDs 80 are mounted compactly on a single substrate. This allows for elimination of connecting members such as connectors and cables for connecting respective substrates to each other, and therefore, it becomes possible to reduce the number of components and to improve reliability of the backlight device. Also, because the plurality of side-emitting LEDs 80 are arranged in two levels in the vertical direction along the light incident surface 71, it becomes possible to double the number of LEDs 80 that can be mounted on the light source 8 without expanding the arrangement space of the light source 8. As a result, the brightness of the backlight device 2 can be enhanced, which improves the display quality of the liquid crystal display device 1.

It is preferable that the height of the light source 8 be the same as that of the light guide plate 7 such that light beams that are respectively emitted from the upper level LEDs 80 and the lower level LEDs 80 enter the light guide plate 7 evenly. Specifically, as shown in FIG. 2, when the middle line between the upper level LEDs 80 and the lower level LEDs 80 of the light source 8 is defined as a center line C1, and as shown in FIG. 1, when the center of the light incident surface 71 of the light guide plate 7 in the vertical direction is defined as a center line C2, it is preferable to make the center line C1 of the light source 8 come level with the center line C2 of the light guide plate 7.

In terms of an arrangement pattern of the upper level LEDs 80a to 80h and the lower level LEDs 80A to 80H, the upper level and lower level LEDs 80 can be arranged so as to be symmetrical about the substrate 10 in the vertical direction as shown in FIG. 2(a), or a staggered arrangement pattern in which the lower level LEDs 80 are respectively placed between the upper level LEDs 80 can be employed as shown in FIG. 2(b).

The staggered arrangement pattern shown in FIG. 2(b) makes it possible to prevent uneven brightness with bright and dark areas, which occurs in the end portion of the light guide plate 7 near the light source 8. When the LEDs 80 are arranged with large spacing therebetween in the light source 8, for example, in the end portion of the light guide plate 7 near the light source 8, areas facing the LEDs 80 become bright, and areas facing the spacing between the LEDs 80 become dark, which causes the uneven brightness with bright and dark areas corresponding to the spacing of the LEDs 80. In contrast, in the staggered arrangement pattern, between the LED 80a and the LED 80b of the upper level, the LED 80B of the lower level is disposed, and therefore, areas of the end portion of the light guide plate 7 that face the spacing between the LEDs 80 do not become dark, thereby preventing the occurrence of uneven brightness with bright and dark areas.

Typically, the optical characteristics of the LEDs 80 vary, and the LEDs 80 are categorized into different optical ranks based on luminance, chromaticity, and the like. If the LEDs 80 used for the light source 8 are randomly selected regardless of the optical ranks thereof, uneven brightness or uneven chromaticity would occur, and therefore, it is necessary to use the plurality of LEDs 80 of the same optical rank. However, using LEDs of the same optical rank lowers the yield ratio, which results in a problem of the higher part cost.

In response to the problem of the optical rank, in the light source 8 shown in FIGS. 2(a) and 2(b), by arranging the individual LEDs 80 with even spacing in the vertical direction and the horizontal direction, and by appropriately combining the LEDs 80 of different optical ranks in the vertical direction and the horizontal direction, the occurrence of uneven brightness or uneven chromaticity can be prevented.

As a combination of the LEDs 80 of different optical ranks, in FIG. 2(a), “a,” “c,” “e,” and “g” of the upper level LEDs 80 can be made of LEDs of a higher optical rank and “b,” “d,” “f,” and “h” can be made of LEDs of a lower optical rank, and A, C, E, and G of the lower level LEDs 80 can be made of LEDs of the lower optical rank, and B, D, F, and H can be made of LEDs of the higher optical rank, for example. As describe above, by alternately arranging the LEDs of the higher optical rank and the LEDs of the lower optical rank, the difference in the optical rank evens out in the light source as a whole, and thus, the occurrence of the uneven brightness or the uneven chromaticity is prevented. This eliminates the need of using the plurality of LEDs 80 of the same optical rank, thereby achieving the reduction in part cost.

When the color reproduction range of the module is to be expanded, the reproduction range can be improved by constituting the light source of a combination of LEDs 80 of respective colors of RGB rather than using pseudo white LEDs. Specifically, the color reproduction range of the pseudo white LEDs (blue chip and yellow fluorescent body) is about 70% relative to the NTSC, but by combining the LEDs of the respective colors of RGB, the color reproduction range can be improved to nearly 100%. However, because this increases the cost and worsens the efficiency, when only the red color needs to be reproduced as dark red, the light source can be configured such that the pseudo white LEDs are used as main LEDs, and the pseudo white LEDs and red LEDs are alternately arranged in the vertical direction. As described, the color combination of the LEDs 80 may be modified suitably for the intended use.

### Embodiment 2

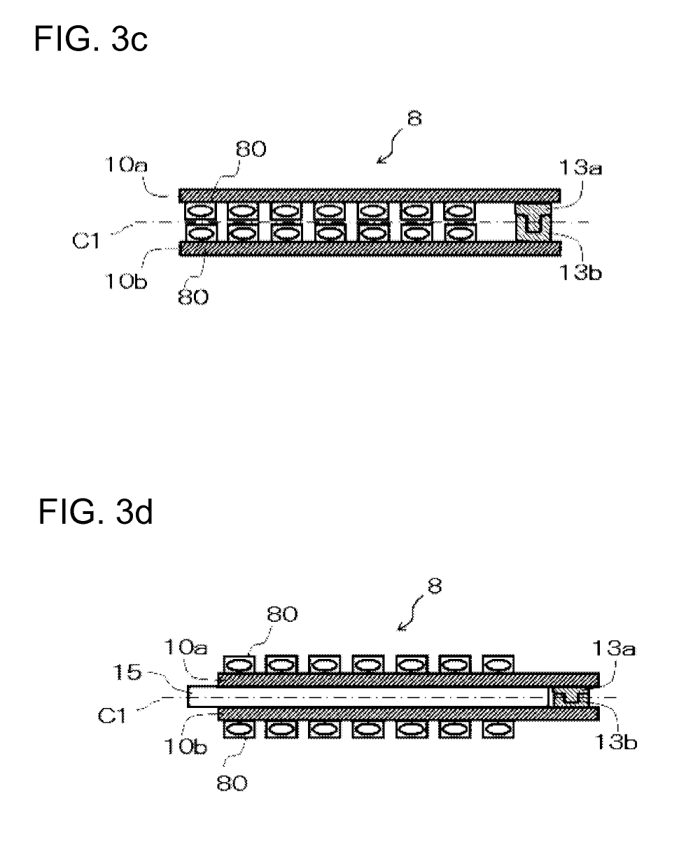

FIG. 3 shows front views of the light source 8 in the backlight device 2 according to Embodiment 2 of the present invention when viewed from the light incident surface 71. This embodiment differs from Embodiment 1 above in the configuration of the light source 8, and because other configurations may be the same as those of Embodiment 1, the detailed descriptions thereof are omitted.

The light source 8 in Embodiment 2 is constituted of an upper level substrate 10a having the upper level LEDs 80 mounted thereon and a lower level substrate 10b having the lower level LEDs 80 mounted thereon, and the upper level substrate 10a and the lower level substrate 10b are connected to each other in the vertical direction. With this configuration, instead of mounting the upper level LEDs 80 and the lower level LEDs 80 on the opposite surfaces of the substrate 10, the LEDs 80 are mounted on respective one surfaces of different substrates 10, and therefore, it becomes easier to mount the LEDs 80, and when one of the LEDs 80 has a problem, it can be fixed only by replacing one substrate. Also, by making a unit of the substrate 10 having the LEDs 80 mounted on one surface thereof such that the light source 8 can be commonly used for the conventional side-lighting type backlight device, the part cost can be reduced.

With reference to FIGS. 3(a) to 3(d), examples of connections between the upper level substrate 10a and the lower level substrate 10b of the light source 8 will be explained. In the light source 8 shown in FIG. 3(a), the upper level substrate 10a having the upper level LEDs 80 and a connecting terminal 12a and the lower level substrate 10b having the lower level LEDs 80 and a connecting terminal 12b are stacked such that the bottom surfaces of the respective substrates 10 face each other, and the connecting terminals 12a and 12b are connected to each other by a cable 14 or the like. With this configuration, because the connecting terminals 12a and 12b can be formed on the substrates 10 together with connecting terminals for connecting the LEDs 80, the manufacturing cost of the substrates 10 can be lowered, and the price thereof can be reduced.

In the light source 8 shown in FIGS. 3(b) and 3(c), the upper level substrate 10a having the upper level LEDs 80 and a connector 13a and the lower level substrate 10b having the lower level LEDs 80 and a connector 13b are stacked in the vertical direction, and the respective connectors 13a and 13b are connected to each other. By using the connectors 13a and 13b, the upper level substrate 10a and the lower level substrate 10b can be connected to each other with ease. Also, by aligning the respective connectors 13a and 13b to each other while placing the upper level substrate 10a and the lower level substrate 10b such that the upper level LEDs 80 and the lower level LEDs 80 are arranged in a vertical symmetrical pattern or in a staggered pattern as shown in FIG. 2, for example, the upper level and lower level LEDs 80 can be properly positioned at the same time as connecting the upper level and lower level substrates 10 to each other by the connectors 13. In the connection example shown in FIG. 3(c), the upper level LEDs 80 and the lower level LEDs 80 can be placed close to each other, which results in a greater effect in correcting the optical ranks between the upper level and lower level LEDs 80.

In the light source 8 shown in FIG. 3(d), the upper level substrate 10a and the lower level substrate 10b are connected to each other by the connectors 13a and 13b, and the upper level substrate 10a and the lower level substrate 10b are bonded and affixed to a bezel 15. The bezel 15 is a frame body that encloses the light guide plate 7, and is used to hold the backlight device 2 as a single unit. The bezel 15 is formed by stamping out and bending a metal plate, for example. By affixing the upper level substrate 10a and the lower level substrate 10b to this bezel 15, heat generated by the LEDs 80 can be transmitted and dissipated through the bezel 15, which prevents thermal deterioration of the LEDs 80 and thereby improves the life thereof.

In the light source 8 shown in FIGS. 3(a) to 3(d), it is also preferable that the height of the light source 8 be the same as that of the light guide plate 7 such that light beams that are respectively emitted from the upper level LEDs 80 and the lower level LEDs 80 enter the light guide plate 7 evenly. Specifically, as shown in FIG. 3, when the middle line between the upper level LEDs 80 and the lower level LEDs 80 of the light source 8 is defined as a center line C1, and as shown in FIG. 1, when the center of the light incident surface 71 of the light guide plate 7 in the vertical direction is defined as a center line C2, it is preferable to make the center line C1 of the light source 8 come level with the center line C2 of the light guide plate 7.

### Embodiment 3

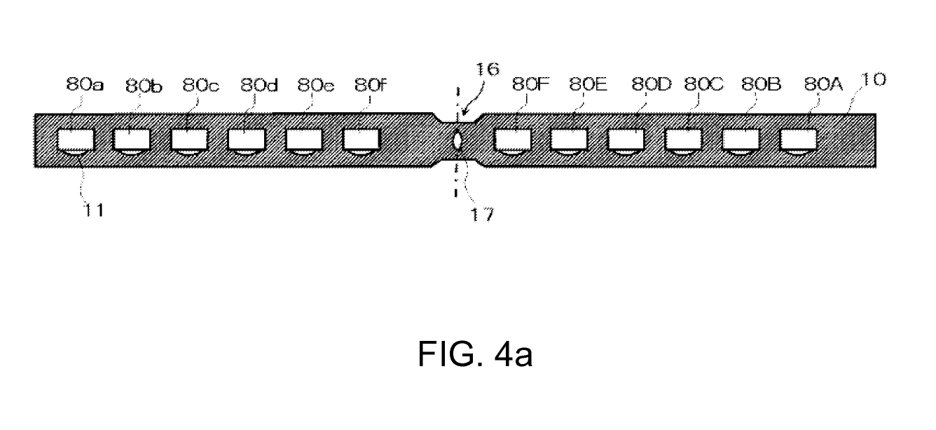

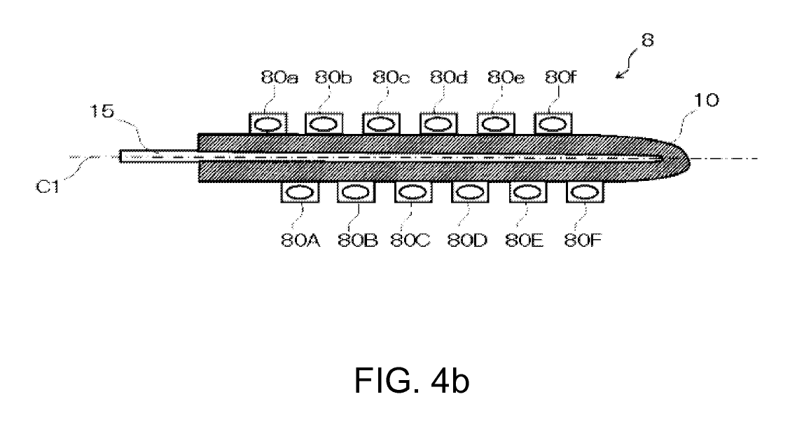

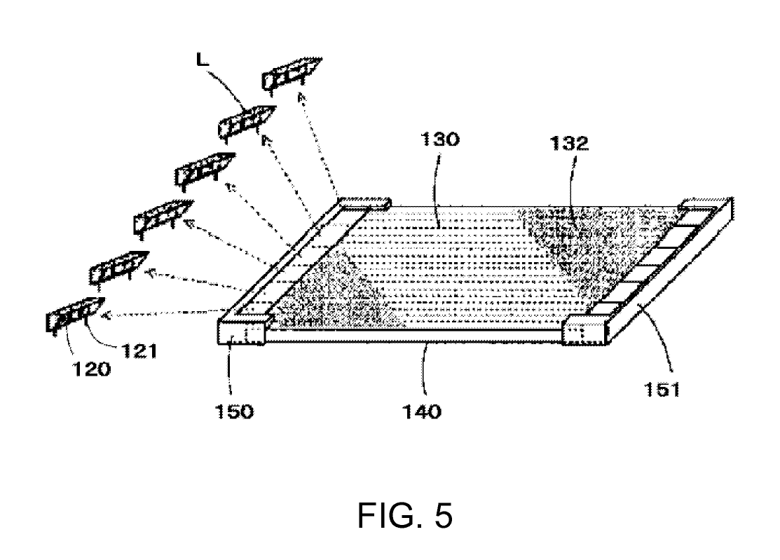

FIG. 4 shows diagrams for illustrating the light source 8 of the backlight device 2 according to Embodiment 3 of the present invention. FIG. 4(a) is a plan view of a substrate 10 having a plurality of LEDs 80 mounted thereon, and FIG. 4(b) is a front view of the completed light source 8 when viewed from the side of the light incident surface 71. This embodiment differs from Embodiment 1 above in a configuration of the light source 8, and because other configurations may be the same as those of Embodiment 1, the detailed descriptions thereof are omitted.

As shown in FIG. 4(a), in the light source 8 of Embodiment 3, the upper level LEDs 80a to 80f and the lower level LEDs 80A to 80F are mounted on one surface of the substrate 10 in the same process, and as shown in FIG. 4(b), the substrate 10 having the plurality of LEDs 80 mounted thereon is folded at the middle of the upper level LEDs 80 and the lower level LEDs 80. The substrate 10 is preferably an FPC having flexibility, and in order to make it easier to fold, a narrowed portion 16 or a slit 17 may be formed between the upper level LEDs 80 and the lower level LEDs 80.

According to Embodiment 3, because the LEDs 80 are mounted only on one surface of the substrate 10, it becomes easier to mount the plurality of LEDs 80 on the substrate 10. Also, because the upper level LEDs 80 and the lower level LEDs 80 are mounted on the same substrate, it is not necessary to connect the upper level LEDs 80 to the lower level LEDs 80 using connecting terminals or connectors, and therefore, the backlight device with a fewer number of components and higher reliability can be achieved.

In the light source 8 shown in FIG. 4(b), it is also preferable that the height of the light source 8 be the same as that of the light guide plate 7 such that light beams that are respectively emitted from the upper level LEDs 80 and the lower level LEDs 80 enter the light guide plate 7 evenly. Specifically, as shown in FIG. 4, when the middle line between the upper level LEDs 80 and the lower level LEDs 80 of the light source 8 is defined as a center line C1, and as shown in FIG. 1, when the center of the light incident surface 71 of the light guide plate 7 in the vertical direction is defined as a center line C2, it is preferable to make the center line C1 of the light source 8 come level with the center line C2 of the light guide plate 7.

Although Embodiments 1 to 3 have been explained above, the present invention is not limited to the above-mentioned embodiments, and various modifications can be made without departing from the scope of the present invention. It is also possible to combine the arrangement pattern or the combination of optical ranks of the LEDs 80 described in Embodiment 1 with Embodiment 2 or Embodiment 3 in implementation, for example.

In Embodiment 3, the substrate 10 may also be bonded and affixed to the bezel 15 in a manner similar to Embodiment 2. By affixing the substrate to the bezel 15, heat generated by the LEDs 80 can be dissipated through the bezel 15, which makes it possible to improve the life of the LEDs 80.

### DESCRIPTIONS OF REFERENCE CHARACTERS

1 liquid crystal display device
2 backlight
3 liquid crystal panel
4 diffusion sheet
5 prism sheet
6 polarizing sheet
7 light guide plate
8 light source
9 reflective sheet
10 substrate
11 light-emitting surface
12a, 12b connecting terminal
13a, 13b connector
14 cable
15 bezel
16 narrowed portion
17 slit
71 light incident surface
72 light emerging surface
80, 120, 121 LED
130 light conductor
140 reflector
150, 151 lamp holder

1. A backlight device, comprising: a light guide plate having a light incident surface on a prescribed side surface; and a light source disposed so as to face the light incident surface of the light guide plate,
wherein the light source is made of a plurality of side-emitting LEDs that are mounted on a substrate, and the plurality of LEDs are arranged in two levels in a vertical direction along the light incident surface.

2. The backlight device according to claim 1, wherein, in the light source, the LEDs of an upper level and the LEDs of a lower level are arranged in a staggered pattern.

3. The backlight device according to claim 1, wherein, in the light source, the LEDsare constituted of a combination of LEDs of different optical ranks.

4. The backlight device according to claim 2, wherein, in the light source, the LEDs are constituted of a combination of LEDs of different optical ranks.

5. The backlight device according to claim 1, wherein, in the light source, the LEDs are constituted of a combination of LEDs having different colors.

6. The backlight device according to claim 1, wherein, in the light source, the LEDs of an upper level are mounted on a top surface of the substrate, and the LEDs of a lower level are mounted on a bottom surface of the substrate.

7. The backlight device according to claim 1, wherein the light source comprises: an upper level substrate having the LEDs of an upper level mounted thereon; and a lower level substrate having the LEDs of a lower level mounted thereon, and the upper level substrate and the lower level substrate are stacked in a vertical direction, and are connected to each other.

8. The backlight device according to claim 1, wherein, in the light source, the LEDs of an upper level and the LEDs of the lower level are mounted on a top surface of the substrate, and the substrate is folded over between the LEDs of the upper level and the LEDs of the lower level.

9. The backlight device according to claim 8, wherein the substrate is a flexible printed board.

10. The backlight device according to claim 7, wherein, in the light source, the substrate is affixed to a frame body that encloses the light guide plate.

11. The backlight device according to claim 10, wherein the frame body is a metal member.

12. A liquid crystal display device, comprising the backlight device according to claim 1.

13. A television receiver, comprising the liquid crystal display device according to claim 12 and a tuner unit that receives television broadcasting.
